(19) United States
(12) Patent Application Publication
(10) Pub. No.: US 2012/0003061 A1
(43) Pub. Date: Jan. 5, 2012

(54) CAGED SLEEVE ASSEMBLY

(76) Inventors: Ross S. Hill, Lansing, MI (US); Michael F. Jeroue, Oakland, MI (US); Kent S. Gimmy, Gallatin, TN (US)

(21) Appl. No.: 13/234,696

(22) Filed: Sep. 16, 2011

Related U.S. Application Data
(63) Continuation-in-part of application No. PCT/US2010/041891, filed on Jul. 14, 2010.
(60) Provisional application No. 61/233,720, filed on Aug. 13, 2009.
(60) Provisional application No. 61/416,651, filed on Nov. 23, 2010.

(51) Int. Cl. F16B 43/00

(52) U.S. Cl. 411/531

(57) ABSTRACT

A caged sleeve assembly includes a cage having a main body defining a washer chamber, at least one washer within the washer chamber, and a centering sleeve secured to the cage. The centering sleeve is configured to center the caged assembly within a through-hole of a wheel component.

### RELATED APPLICATIONS

The present application is a continuation-in-part of PCT/US2010/041891 entitled “Caged Sleeve Assembly,” filed Jul. 14, 2010 (published as WO 2011/019471), which relates to and claims priority benefits from U.S. Provisional Patent Application 61/233,720 entitled “Nut and Sleeve Combination,” filed Aug. 13, 2009, both of which are hereby incorporated by reference in their entireties.

The present application also relates to and claims priority benefits from U.S. Provisional Patent Application 61/416,651 entitled “Caged Sleeve Assembly,” filed Nov. 23, 2010, which is also incorporated by reference in its entirety.

### FIELD OF EMBODIMENTS OF THE INVENTION

Embodiments of the present invention provide a caged sleeve assembly configured to minimize angular movement or “clocking” of wheel assemblies.

### BACKGROUND

Various vehicles utilize a hub-piloted flat mounting system with respect to a wheel assembly. For a variety of reasons, a wheel end may progressively lose tension. The diametric tolerance between a bolt and a bolt hole of the wheel is relatively large. The tolerance allows angular movement or “clocking” that, in turn, may cause the wheels to wear.

FIG. 1 illustrates a top isometric view of a known sleeve nut 10. The sleeve nut 10 includes a nut 12 integrally connected to a sleeve 14. A central threaded channel 16 is formed through the nut 12 and the sleeve 14 and is configured to threadably retain a bolt. A washer 18 is positioned around the sleeve 14 underneath the nut 12. The sleeve nut 10 may be used to minimize wheel movement, for example.

FIG. 2 illustrates a front view of a known centering sleeve 20. The centering sleeve 20 includes a main column 22 connected to a collar 24. The collar 24 is configured to support a cage, as noted below. Notably, the sleeve 20 is not integrally formed with or connected to a nut.

FIG. 3 illustrates a front view of a known cage 26. The cage 26 includes a main body 28 configured to retain washers (not shown in FIG. 3). The main body 28 connects to a flange 30 that is configured to seat on the collar 24 of the sleeve 20 (shown in FIG. 2).

Referring to FIGS. 2 and 3, the cage 26 seats on the collar 24. A bolt is positioned through central passages of the sleeve 20 and the cage 26 to secure the cage 26 and sleeve 20 together. Accordingly, the cage 26 and the sleeve 20 may be used to align outer halves, such as a wheel, of a two-piece wheel assembly. A through-hole of a wheel is urged over the bolt. The main column 22 may also be positioned within the same through-hole and over the same bolt. The cage 26 is then threaded onto the bolt and positioned on top of the collar 24, thereby securing the wheel, sleeve 20, and cage 26 together.

Additionally, a collared sleeve may be placed into bolt holes and a nut may be positioned on top of the sleeve in order to align inner and outer halves of a two-piece wheel.

However, the cage 26 and the sleeve 20 may be mis-aligned during initial positioning. Further, a collared sleeve may be mis-aligned with the nut. Therefore, when a bolt is passed therethrough, the components may improperly secure together.

### SUMMARY OF EMBODIMENTS OF THE INVENTION

Certain embodiments of the present invention provide a caged sleeve assembly that includes a cage having a main body defining a washer chamber, at least one washer within the washer chamber, and a centering sleeve secured to the cage. The centering sleeve is configured to center the caged assembly within a through-hole of a wheel component.

The centering sleeve secures to the cage without the use of a separate and distinct fastener. While the assembly is still configured to receive and retain a bolt, the bolt is not necessary to secure the cage to the sleeve.

The centering sleeve may include an open-ended shaft integrally connected to an out-turned collar. The out-turned collar may be compressively sandwiched between the washer and a base of the cage. Optionally, the out-turned collar may be compressively sandwiched between at least one folded-over tab of the cage and the washer.

The assembly may also include an annular flange secured to at least a portion of a base of the cage. The annular flange may be integrally formed with the centering sleeve. That is, the annular flange may be molded or otherwise formed as a single, unitary flanged sleeve. At least a portion of the base may secure to an inner ridge or notch formed in the flange.

The centering sleeve may include a threaded end. The washer may threadably secure to the threaded end. The washer may be compressively sandwiched between a base of the cage and an additional washer within the washer chamber. The washer may have a larger central opening than additional washers within the washer chamber positioned over the washer. Further, the washer may have a first thread pitch, and the additional washers have a thread pitch that differs from the first thread pitch.

Certain embodiments of the present invention provide an assembly in which at least one washer includes a chamfered interior rim, and the centering sleeve may include an out-turned end that engages the chamfered interior rim to compressively secure the at least one washer between the centering sleeve and a base of the main body of the cage.

Certain embodiments of the present invention provide an assembly in which the at least one washer includes a first washer having a first inner diameter, and a second washer having a second inner diameter. The first inner diameter is greater than the second inner diameter. The centering sleeve may include an out-turned end that is secured in position by the first and second washers.

Certain embodiments of the present invention provide a thrust washer that secures the main body of the cage to the centering sleeve. The thrust washer may include a base ledge having a recessed notch that receives and retains an out-turned portion of the centering sleeve.

Certain embodiments of the present invention provide a caged sleeve assembly that includes a hexagonal cage including a main body having a base at one end and tabs at an opposite end, wherein the main body defines an internal washer chamber; first, second, third and fourth hexagonal washers within the washer chamber, wherein the tabs are folded over the fourth washer to secure the washers within the washer chamber between the tabs and the base; and a centering sleeve secured to the cage, wherein the centering sleeve is configured to center the caged assembly within a through-hole of a wheel component.

The first washer may be distally located from the fourth washer. For example, the first washer may be the bottom washer within the cage, while the fourth washer may be the top washer within the cage. The first washer may include a chamfered interior rim, and the centering sleeve may include an out-turned end that engages the chamfered interior rim to compressively secure the first washer between the centering sleeve and a base of the main body of the cage.

Alternatively, the assembly may include fifth and sixth washers. The fifth washer has a first inner diameter, and the sixth washer has a second inner diameter. The first inner diameter is greater than the second inner diameter. The centering sleeve includes an out-turned end that is secured in position by the fifth and sixth washers.

The assembly may include a thrust washer that secures the main body of the hexagonal cage to the centering sleeve. The thrust washer may include a base ledge having a recessed notch that receives and retains an out-turned portion of the centering sleeve.

Certain embodiments of the present invention provide a caged sleeve assembly that includes a cage having a washer chamber, a plurality of washers within the washer chamber, and a centering sleeve secured to the cage. The centering sleeve secures to the cage without the use of a separate and distinct internal fastener (that is, a fastener that passes through the assembly, such as a bolt or screw).

### BRIEF DESCRIPTION OF SEVERAL VIEWS OF THE DRAWINGS

FIG. 1 illustrates a top isometric view of a known sleeve nut.

FIG. 2 illustrates a front view of a known centering sleeve.

FIG. 3 illustrates a front view of a known cage.

FIG. 4 illustrates a cross-sectional view of a caged sleeve assembly, according to an embodiment of the present invention.

FIG. 5 illustrates a cross-sectional view of a caged sleeve assembly, according to an embodiment of the present invention.

FIG. 6 illustrates an isometric front view of a flanged sleeve, according to an embodiment of the present invention.

FIG. 7 illustrates an isometric top view of a flanged sleeve, according to an embodiment of the present invention.

FIG. 8 illustrates a top view of a flanged sleeve, according to an embodiment of the present invention.

FIG. 9 illustrates a cross-sectional view of a flanged sleeve through line 9-9 of FIG. 8, according to an embodiment of the present invention.

FIG. 10 illustrates a cross-sectional view of a caged sleeve assembly, according to an embodiment of the present invention.

FIG. 11 illustrates a cross-sectional view of a caged sleeve assembly with washers, according to an embodiment of the present invention.

FIG. 12 illustrates an isometric top view of a sleeve, according to an embodiment of the present invention.

FIG. 13 illustrates an isometric top view of a washer, according to an embodiment of the present invention.

FIG. 14 illustrates an isometric top view of a washer secured to a sleeve, according to an embodiment of the present invention.

FIG. 15 illustrates a front view of a caged sleeve assembly, according to an embodiment of the present invention.

FIG. 16 illustrates a top view of a caged sleeve assembly, according to an embodiment of the present invention.

FIG. 17 illustrates a cross-sectional view of a caged sleeve assembly through line 17-17 of FIG. 16, according to an embodiment of the present invention.

FIG. 18 illustrates a cross-sectional view of a caged sleeve assembly, according to an embodiment of the present invention.

FIG. 19 illustrates a cross-sectional view of a caged sleeve assembly, according to an embodiment of the present invention.

FIG. 20 illustrates a cross-sectional view of a caged sleeve assembly, according to an embodiment of the present invention.

FIG. 21 illustrates a cross-sectional view of a two-piece sleeve and thrust washer, according to an embodiment of the present invention.

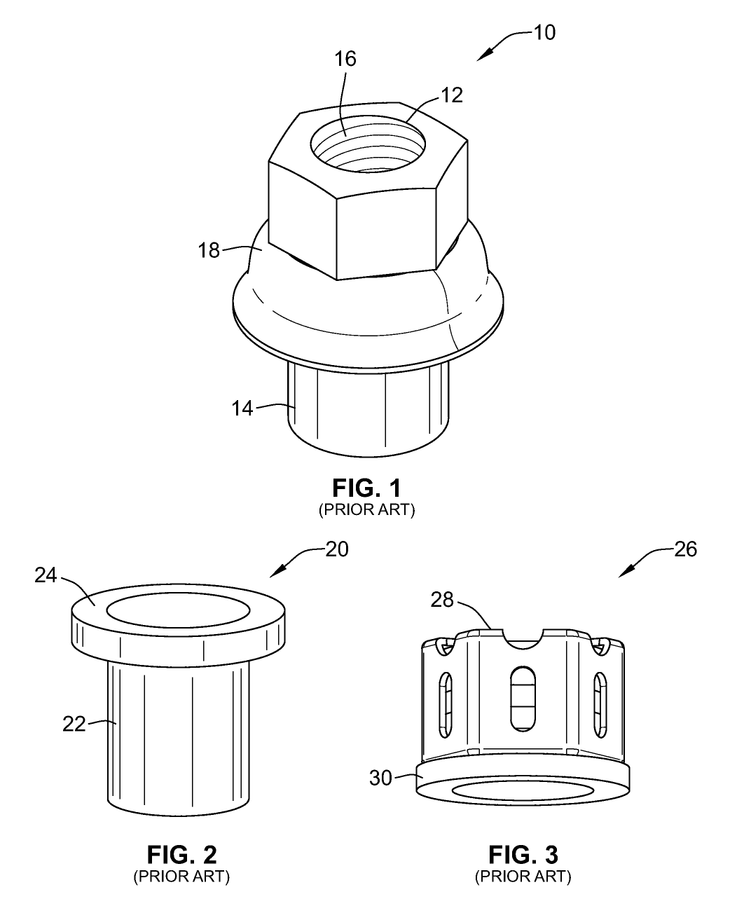

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

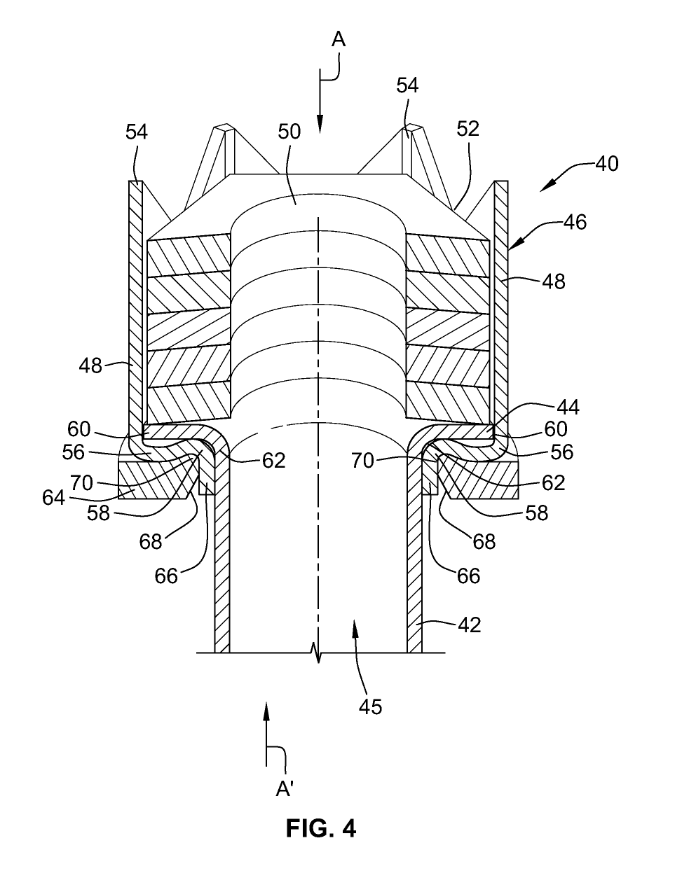

FIG. 4 illustrates a cross-sectional view of a caged sleeve assembly 40, according to an embodiment of the present invention. The assembly 40 includes an open-ended cylindrical sleeve 42 having an out-turned collar 44. The sleeve 42 includes a central passage 45 formed therethrough. The central passage 45 is configured to receive a bolt shaft.

A cage 46 is securely mounted to the sleeve 42. The cage 46 includes upstanding outer walls 48 that define a washer chamber 50. The walls 48 may form a hexagonal shape in order to accommodate hexagonal washers 52 that are contained within the washer chamber 50. However, the walls 48 and the washers 52 may be various other shapes. The angled shapes of the walls 48 and washers 52, however, ensure that the washers 52 do not axially rotate within the washer chamber 50. Further, the cage 46 may be configured to retain more or less washers 52 than shown.

Tabs 54 extend from upper portions of the walls 48. As shown in FIG. 4, the tabs 54 are aligned with the walls 48 in order to allow the washers 52 to be loaded into the washer chamber 50. After the washers 52 are positioned within the washer chamber 50, the tabs 54 may be folded over the top washer 52 in order to securely compress the washers 52 in position.

A base 56 integrally connects to bottom portions of the walls 48 and is generally perpendicular to the walls 48. However, as shown in FIG. 4, the base 56 has a distal end 58 that curves upward with increased distance toward the central axis of the assembly 40. Outer edges 60 of the collar 44 of the sleeve 42 abut into inner surfaces of the walls 48 just above the base 56. The distal ends 58 of the base 56, in turn, abut into an outer surface of the sleeve 42 proximate a junction 62 of the collar 44 and the main shaft of the sleeve 42, thereby wedging the cage 46 to the sleeve 42.

An annular flange 64 having a central opening is positioned around a hollow post 66 that extends downwardly from the distal ends 58 of the base 56. The flange 64 may be thicker and more robust than either the sleeve 42 or the cage 46, as shown in FIG. 4. The thick, robust nature of the flange 64 provides greater clamping force.

Once the tabs 54 are folded over in order to secure the washers 52 in place, the washers 52 exert a compressive force into the top of the collar 44 of the sleeve 42 in the direction of arrow A. At the same time, the flange 64 compresses the base 56 of the cage 46 into the collar 44 in the direction of arrow A′. Accordingly, the cage 46 and sleeve 42 are securely fastened together.

The flange 64 includes tapered inner edges 68 that define a central opening that decreases in width from a bottom surface to an upper surface of the flange 64. Accordingly, an upper interior edge 70 compressively urges the distal ends 58 of the base 56 into the junction 62 of the sleeve 42, thereby compressively sandwiching the base 56 into the junction 62 of the sleeve 42. As such, the flange 64 assists in securely fixing the cage 46 to the sleeve 42.

A bolt (not shown) may be passed through the interior passage defined by the sleeve 42 and the washers 52.

As explained above, a method to secure the cage 46 to the sleeve 42 includes moving the sleeve 42 into the washer chamber 50 so that the collar 44 of the sleeve 42 rests on the base 56 of the cage 46. The flange 64 may be secured around a portion of the cage 46, thereby urging a portion of the base 56 into the collar 44. The washers 52 may then be loaded into the washer chamber 50, and the tabs 54 may be folded over the washers 52, thereby compressing the collar 44 between the lower washer 52 and the base 56 of the cage 46.

Optionally, the washers 52 may be loaded into the washer chamber 50 and secured therein by the folded-over tabs 54, before the flange 64 is positioned around a portion of the cage 46. In this manner, the collar 44 of the sleeve 42 is compressively sandwiched between the lower washer 52 and the base 56 of the cage 46.

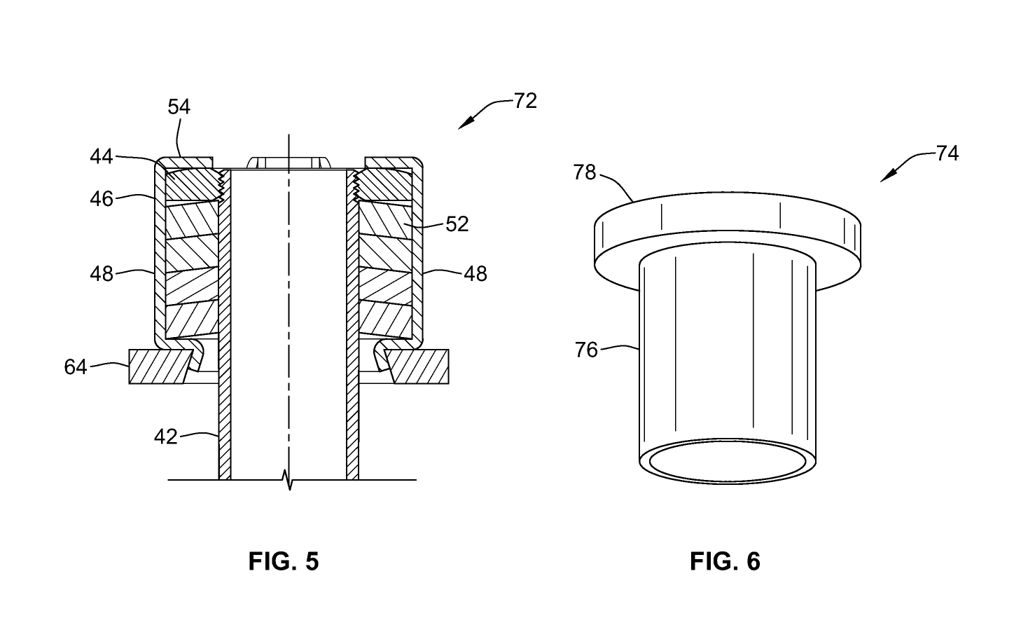

FIG. 5 illustrates a cross-sectional view of a caged sleeve assembly 72, according to an embodiment of the present invention. The assembly 72 is similar to the assembly 40, except that the collar 44 is sandwiched between folded-over tabs 54 and the top washer 52, thereby securing the sleeve 42 to the cage 46. Optionally, the collar 44 and sleeve 42 may be integrally formed as a single piece. Also, alternatively, the collar 44 may be shaped as a convex washer, like the top washer 52.

Thus, a method to secure the cage 46 to the sleeve 42 includes loading the cage 46 with the washers 52. After the washers 52 are within the washer chamber 50, the shaft of the sleeve 42 is urged into the central passage defined by the washers 52 until the collar 44 rests on the top washer 52. At this point, the tabs 54 of the cage 46 are folded over the top surface of the collar 44, thereby compressively sandwiching the collar 44 between the tabs 54 and the top washer 52. Accordingly, the sleeve 42 securely fastens to the cage 46.

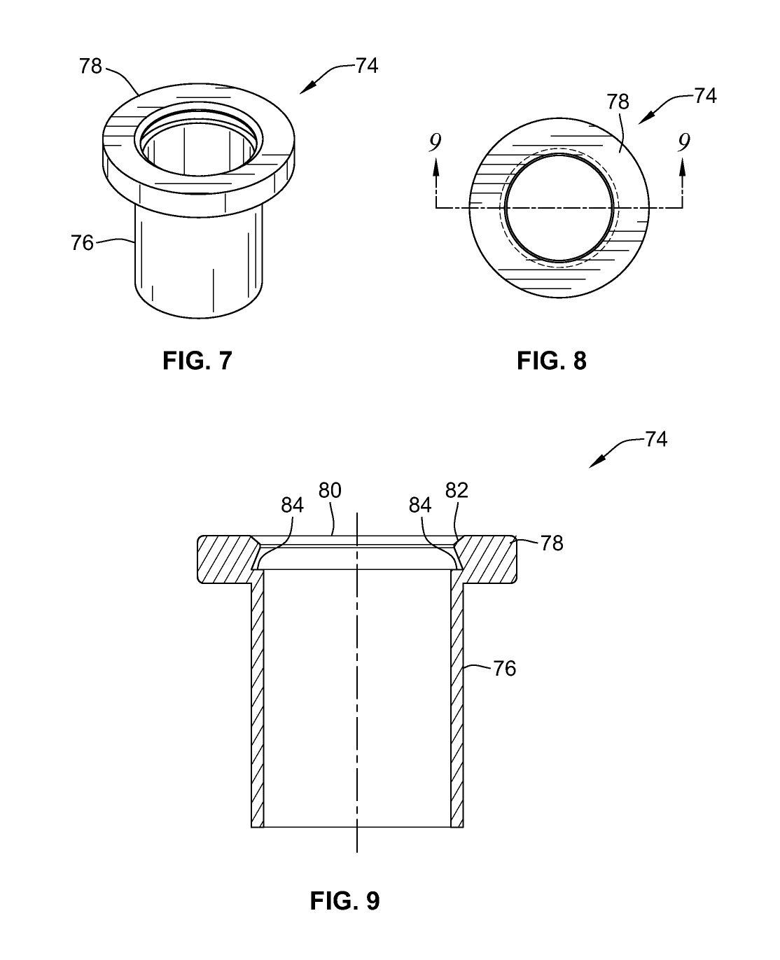

FIGS. 6 and 7 illustrate isometric front and top views, respectively, of a flanged sleeve 74, according to an embodiment of the present invention. The flanged sleeve 74 integrally combines a sleeve 76 with an annular flange 78 into a single, unitary piece.

FIG. 8 illustrates a top view of the flanged sleeve 74, while FIG. 9 illustrates a cross-sectional view of the flanged sleeve 74 through line 9-9 of FIG. 8. As shown in FIG. 9, the annular flange 78, which is thicker than the sleeve 76, integrally extends from top edges of the sleeve 76.

An opening 80 is formed through the flange 78. The diameter of the of the opening 80 decreases toward an angled ledge 82. The diameter of the opening 80 proximate the bottom of the flange 78 is wider than at the level of the angled ledge 82, and may be as wide as the top of the opening 80. A collar ledge 84 is formed at a bottom of the flange 78. Optionally, the opening 80 may simply taper at a constant rate from top to bottom.

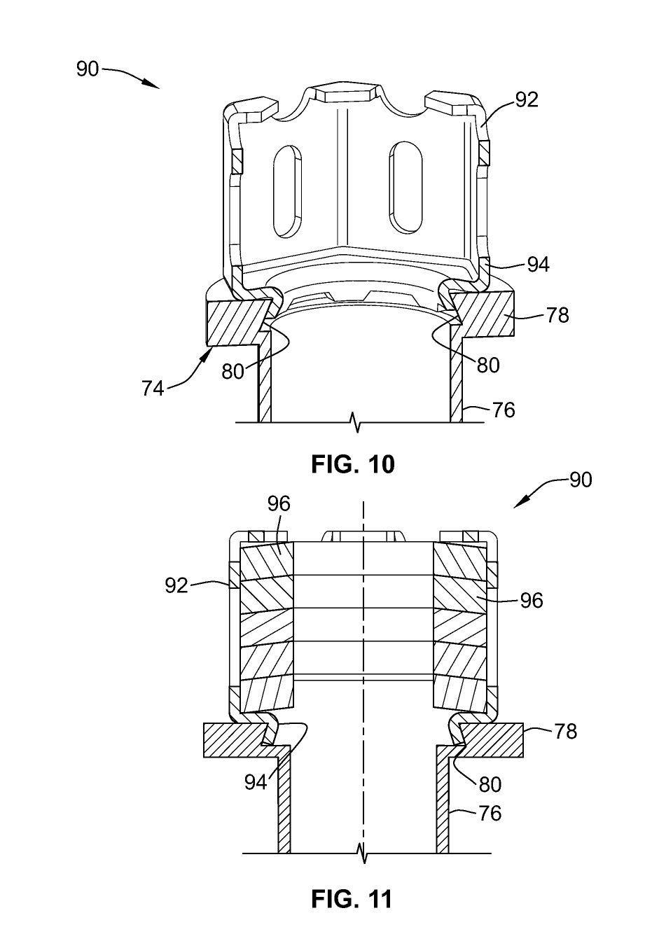

FIG. 10 illustrates a cross-sectional view of a caged sleeve assembly 90, according to an embodiment of the present invention. A cage 92 including a lower base 94 is securely fastened to the flanged sleeve 74. The base 94 is folded or crimped into the opening 80. That is, the base 94 is folded into the opening 80 defined by the flange 78, thereby securely crimping the cage 92 to the flanged sleeve 74.

FIG. 11 illustrates a cross-sectional view of the caged sleeve assembly 90 with washers 96, according to an embodiment of the present invention. Thus, the caged sleeve assembly 90 provides a unitary construction in which the cage 92 is securely fastened to the sleeve 76.

Thus, a method of securing the cage 92 into the flange 78 of the flanged sleeve 74 includes crimping or otherwise conforming the base 94 onto or into a ridge or notch formed on an interior surface of the flange 78. The base 94 may be folded over, under, or into a ridge or notch of the annular flange 78.

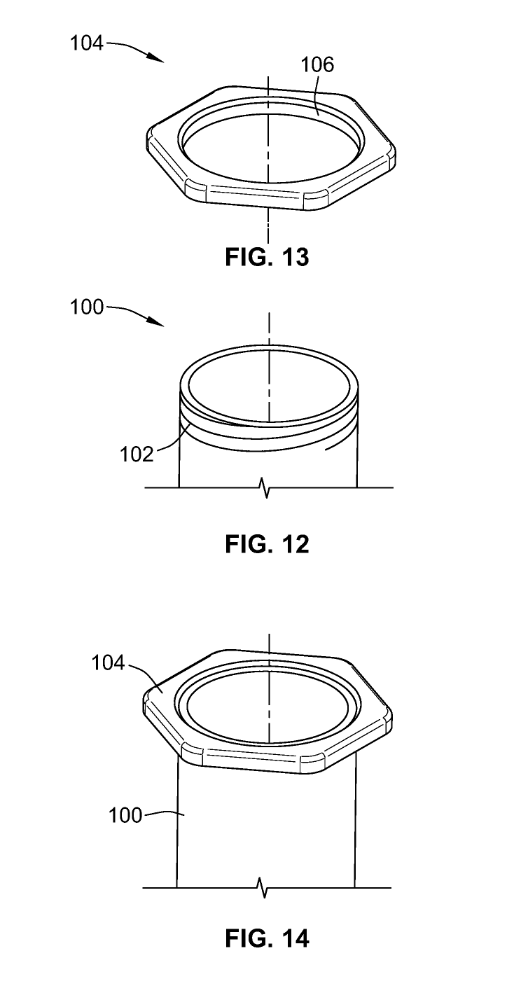

FIG. 12 illustrates an isometric top view of a sleeve 100, according to an embodiment of the present invention. The sleeve 100 is a cylindrical hollow shaft. An upper portion 102 of the sleeve 100 is threaded in order to threadably engage a washer.

FIG. 13 illustrates an isometric top view of a washer 104, according to an embodiment of the present invention. The washer 104 includes a threaded inner annular surface 106 that is configured to threadably engage the upper portion 102 of the sleeve 100.

FIG. 14 illustrates an isometric top view of the washer 104 secured to the sleeve 100 according to an embodiment of the present invention. The washer 104 is threadably secured to the threaded upper portion 102 (hidden from view in FIG. 14) of the sleeve 100.

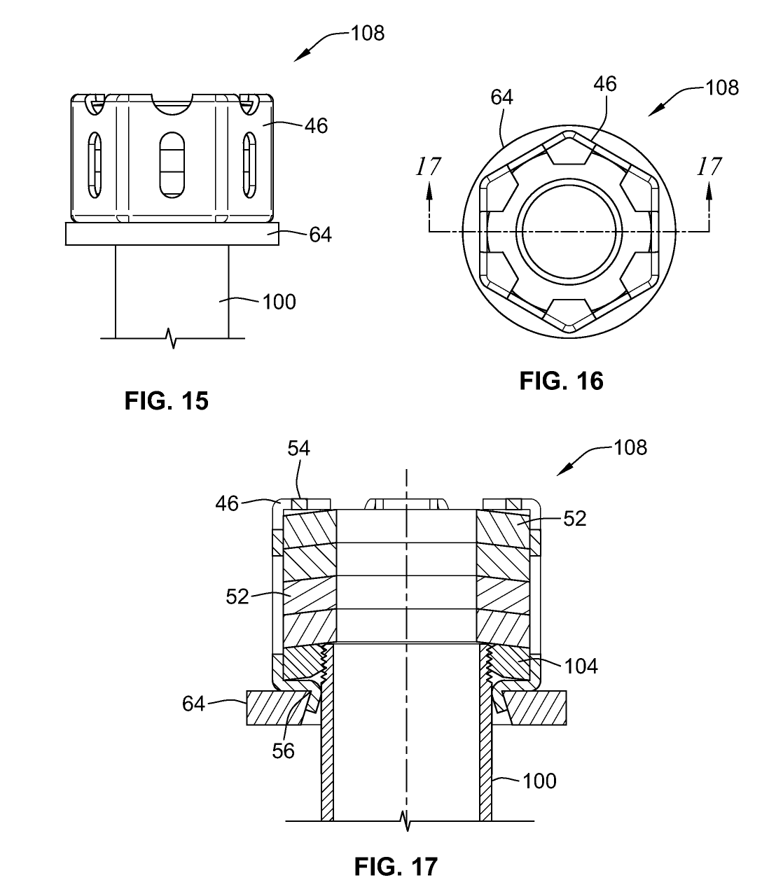

FIGS. 15 and 16 illustrate front and top views, respectively, of a caged sleeve assembly 108, according to an embodiment of the present invention. Referring to FIGS. 15 and 16, the assembly 108 includes the sleeve 100 secured to the washer 104 (hidden from view in FIGS. 15 and 16), the cage 46 (shown and discussed with respect to FIG. 4), and the flange 64 (shown and discussed with respect to FIG. 4).

FIG. 17 illustrates a cross-sectional view of the caged sleeve assembly 108 through line 17-17 of FIG. 16. In order to manufacture the assembly 108, the sleeve 100 is passed through the cage 46 until the washer 104 abuts the base 56, which prevents the washer 104 from passing through. Additional washers 52 are positioned over the washer 104, and the tabs 54 are folded over the top washer 52, thereby securely compressing the washers 52 and 104 in place. Because the washer 104 is lodged in the cage 46 between the base 56 and the adjacent washer 52, the sleeve 100, which is threadably secured to the washer 104, is securely fixed to the cage 46. The flange 64 provides additional fastening, as discussed above with respect to FIG. 4.

The thread pitch of the washer 104 may be different than the thread pitch of the washers 52. It has been found that the differing thread pitch assists in securing the sleeve 100 to the cage 46.

Alternatively, any of the washers 104 and 52 may be shaped as flat, convex, or other such washers.

Additionally, as shown in FIG. 17, the central opening of the washer 104 is greater than that of the washers 52. This is to ensure that the washer 104 threadably engages around the threaded end of the sleeve 100, while allowing a bolt to pass through the sleeve 100 and engage the washers 52.

Optionally, the washers 52 and 104 may all be placed in the cage 46 before the sleeve 100 threadably engages the washer 104. After the tabs 54 are folded over the top washer 52, thereby securing the washers 52 and 104 in the washer chamber of the cage 46, the sleeve 100 may be urged into the washer chamber and threadably secured to the washer 104.

Accordingly, the caged sleeve assembly 108 provides a sleeve 100 securely fixed to a cage 46 before being positioned on components of a wheel assembly.

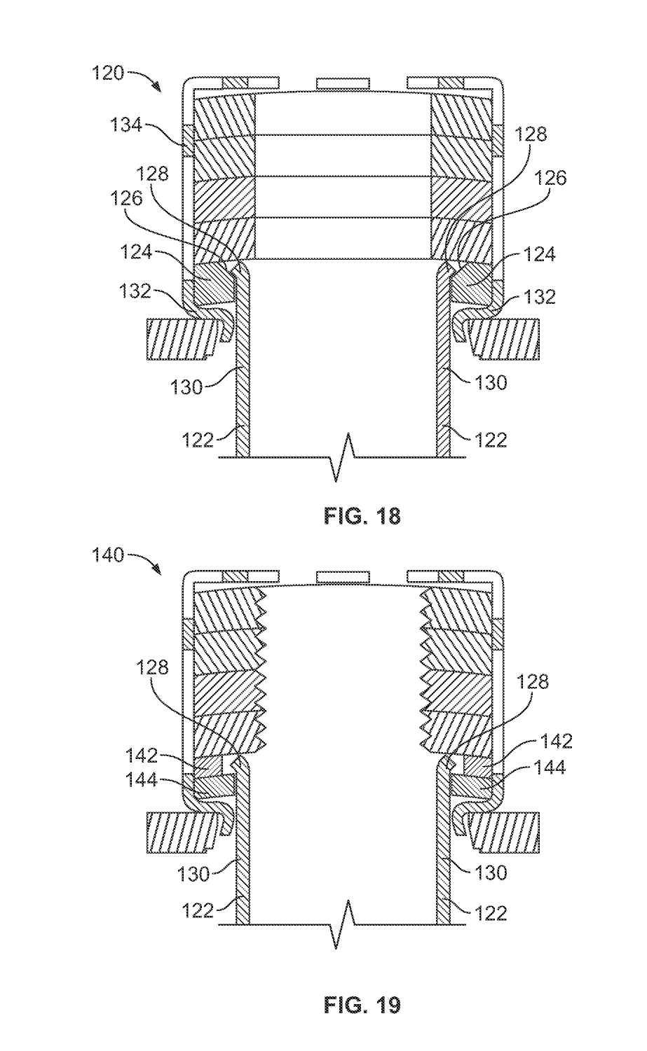

FIG. 18 illustrates a cross-sectional view of a caged sleeve assembly 120, according to an embodiment of the present invention. The assembly 120 shown in FIG. 18 is similar to that shown in FIG. 17, except that instead of a threaded connection between the sleeve 122 and the lower washer 124, the lower washer 124 has a chamfered interior rim 126, and the sleeve 122 includes an out-turned end 128 that wedges into and over the chamfered interior rim 126 of the lower washer 124.

As shown, the interior rim 126 is chamfered such that an interior diameter proximate a top surface of the lower washer 124 is greater than an interior diameter below the top surface. In other words, the opening defined by the chamfered interior rim decreases from top to bottom, as shown in FIG. 18. Further, the chamfered interior rim 126 is a straight edge that angles down from top to bottom. The out-turned end 128 of the sleeve 122 conforms over at least a portion of the chamfered interior rim to compressively wedge the lower washer 124 between the out-turned end 128, the shaft 130 of the sleeve 122, and the base 132 of the cage 134.

Alternatively, the chamfered interior rim 126 may extend over an entire interior surface of the lower washer 124. For example, the chamfered interior rim 126 may begin angling from any upper portion of the lower washer 124 and continue to angle to any interior surface of the lower washer 124. Thus, while the cross-section of the lower washer 124 is shown as diamond-shaped in FIG. 18, the cross-section may resemble a triangle, and all shapes in-between. With changing shapes of the lower washer 124, the angle of the out-turned end 128 of the sleeve 122 will change accordingly.

Also, alternatively, the washers may be shaped as flat, convex, or other such washers.

FIG. 19 illustrates a cross-sectional view of a caged sleeve assembly 140, according to an embodiment of the present invention. In this embodiment, instead of a threaded sleeve, two lower washers 142 and 144 are used. The top lower washer 142 includes a first internal diameter, while the bottom lower washer 144 includes a second internal diameter. The first internal diameter is greater than the second internal diameter. The stacked arrangement of the washers 142 and 144 prevents the out-turned end 128 from passing out of the bottom lower washer 144.

The washers may be shaped as flat, convex, or other such washers.

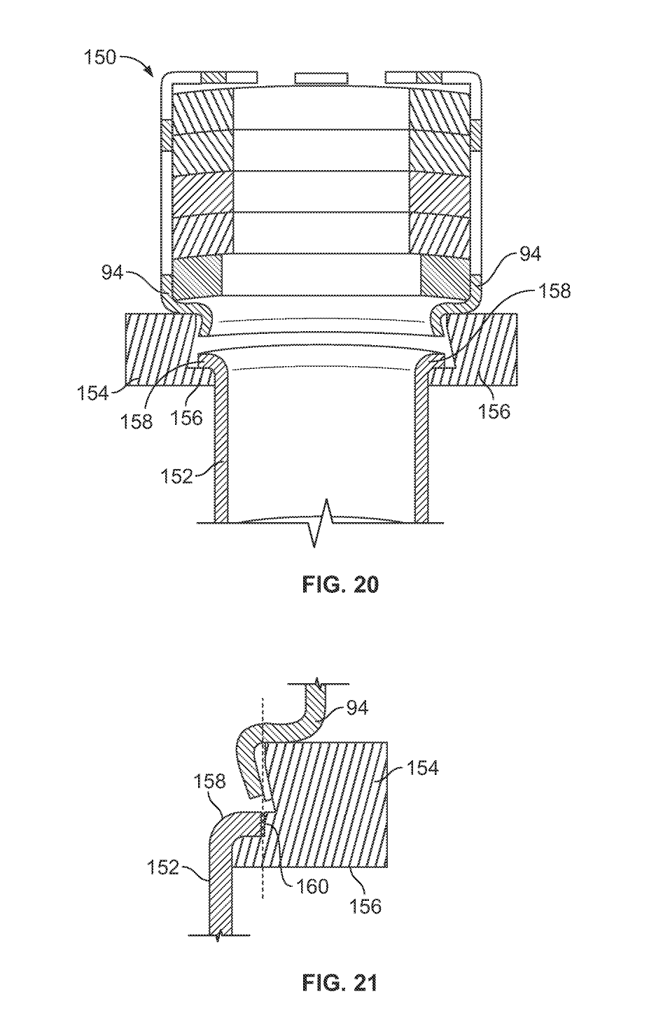

FIG. 20 illustrates a cross-sectional view of a caged sleeve assembly 150, according to an embodiment of the present invention. The assembly 150 is similar to the embodiment shown in FIG. 10, for example, except that the sleeve 152 is not integrally formed with the flange 154. Instead, the flange 154 is in the form of a thrust washer having a base ledge 156 over which an out-turned end 158 of the sleeve 152 rests.

FIG. 21 illustrates a cross-sectional view of a two-piece sleeve 152 and thrust washer 154, according to an embodiment of the present invention. In this embodiment, a recessed inner ledge 160 is formed in the base ledge 156. The out-turned end 158 of the sleeve 152 rests within the recessed inner ledge 160. As such, an upper surface of the out-turned end 158 may be flush with the upper surface of the base ledge 156. The recessed inner ledge 160 or notch formed within the base ledge 156 provides a more secure and stable connection between the sleeve 152 and the thrust washer 154.

Thus, embodiments of the present invention provide systems and methods for securely fastening a cage to a sleeve.

Certain embodiments of the present invention, as described above, provide caged sleeve assemblies that are easily and efficiently formed as a single piece. Accordingly, embodiments of the present invention provide assemblies that minimize mis-alignment during manufacture and use when securing wheel components together.

Moreover, embodiments of the present invention provide assemblies that secure a cage to a sleeve without the use of separate fasteners or welding, for example. The assemblies secure a cage to a sleeve without an intervening bolt passing therethrough. While the assemblies are still configured to retain and align a bolt, the bolt is not needed to secure the cage to sleeve.

Embodiments of the present invention minimize wheel movement that can occur over time with braking, acceleration, and turning. It has been found that embodiments of the present invention minimize angular movement.

The external diameters of sleeves of the caged sleeve assemblies shown and described with respect to FIGS. 4-21 act as centering pilots. Embodiments of the present invention minimize movement between wheel components, thereby maintaining wheel integrity over time.

Embodiments of the present invention minimize angular movement of “clocking” and maintain wheel tension over time. The additional time extends the window for detection of a loose wheel joint.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A caged sleeve assembly comprising:
a cage comprising a main body defining a washer chamber;
at least one washer within said washer chamber; and
a centering sleeve secured to said cage, wherein said centering sleeve is configured to center the caged assembly within a through-hole of a wheel component.

2. The assembly of claim 1, wherein said centering sleeve secures to said cage without the use of a separate and distinct internal fastener.

3. The assembly of claim 1, wherein said centering sleeve comprises an open-ended shaft integrally connected to an out-turned collar.

4. The assembly of claim 3, wherein said out-turned collar is compressively sandwiched between said at least one washer and a base of said cage.

5. The assembly of claim 3, wherein said out-turned collar is compressively sandwiched between at least one folded-over tab of said cage and said at least one washer.

6. The assembly of claim 1, further comprising an annular flange secured to at least a portion of a base of said cage.

7. The assembly of claim 6, wherein said annular flange is integrally formed with said centering sleeve.

8. The assembly of claim 6, wherein said at least a portion of said base secures to an inner ridge or notch formed in said flange.

9. The assembly of claim 1, wherein said centering sleeve comprises a threaded end, and wherein said at least one washer threadably secures to said threaded end.

10. The assembly of claim 9, wherein said at least one washer is compressively sandwiched between a base of said cage and an additional washer within said washer chamber.

11. The assembly of claim 9, wherein said at least one washer has a larger central opening than additional washers within said washer chamber positioned over said at least one washer.

12. The assembly of claim 11, wherein said at least one washer has a first thread pitch, and said additional washers have a second thread pitch, wherein said first thread pitch differs from said second thread pitch.

13. The assembly of claim 1, wherein said at least one washer comprises a chamfered interior rim, and said centering sleeve comprises an out-turned end that engages said chamfered interior rim to compressively secure said at least one washer between said centering sleeve and a base of said main body of said cage.

14. The assembly of claim 1, wherein said at least one washer comprises a first washer having a first inner diameter, and a second washer having a second inner diameter, wherein said first inner diameter is greater than said second inner diameter, and wherein said centering sleeve comprises an out-turned end that is secured in position by said first and second washers.

15. The assembly of claim 1, further comprising a thrust washer that secures said main body of said cage to said centering sleeve.

16. The assembly of claim 15, wherein said thrust washer comprises a base ledge having a recessed notch that receives and retains an out-turned portion of said centering sleeve.

17. A caged sleeve assembly comprising:
a hexagonal cage comprising a main body having a base at one end and tabs at an opposite end, wherein said main body defines an internal washer chamber;
first, second, third and fourth hexagonal washers within said washer chamber, wherein said tabs are folded over said fourth washer to secure said washers within said washer chamber between said tabs and said base; and
a centering sleeve secured to said cage, wherein said centering sleeve is configured to center the caged assembly within a through-hole of a wheel component.

18. The assembly of claim 17, wherein said first washer is distally located from said fourth washer, and wherein said first washer comprises a chamfered interior rim, and said centering sleeve comprises an out-turned end that engages said chamfered interior rim to compressively secure said first washer between said centering sleeve and a base of said main body of said cage.

19. The assembly of claim 17, further comprising fifth and sixth washers, wherein said fifth washer has a first inner diameter, and said sixth washer has a second inner diameter, wherein said first inner diameter is greater than said second inner diameter, and wherein said centering sleeve comprises an out-turned end that is secured in position by said fifth and sixth washers.

20. The assembly of claim 17, further comprising a thrust washer that secures said main body of said hexagonal cage to said centering sleeve.

21. The assembly of claim 20, wherein said thrust washer comprises a base ledge having a recessed notch that receives and retains an out-turned portion of said centering sleeve.

22. A caged sleeve assembly comprising:
a cage having a washer chamber;
a plurality of washers within said washer chamber; and
a centering sleeve secured to said cage, wherein said centering sleeve secures to said cage without the use of a separate and distinct internal fastener.

23. The assembly of claim 22, wherein one of said plurality of washers comprises a chamfered interior rim, and said centering sleeve comprises an out-turned end that engages said chamfered interior rim to compressively secure said one of said plurality of washers between said centering sleeve and a base of said cage.

24. The assembly of claim 22, wherein said plurality of washers comprise a first washer having a first inner diameter, and a second washer having a second inner diameter, wherein said first inner diameter is greater than said second inner diameter, and wherein said centering sleeve comprises an out-turned end that is secured in position by said first and second washers.

25. The assembly of claim 22, further comprising a thrust washer that secures said cage to said centering sleeve.

26. The assembly of claim 25, wherein said thrust washer comprises a base ledge having a recessed notch that receives and retains an out-turned portion of said centering sleeve.
